(19) United States
(12) Patent Application Publication
(10) Pub. No.: US 2009/0051832 A1
(43) Pub. Date: Feb. 26, 2009

(54) Portable image projection device

(76) Inventors: Philip Banks, South Australia (AU); Luceille Outhred, South Australia (AU); Kevin Soper, South Australia (AU)

Correspondence Address: BIO INTELLECTUAL PROPERTY SERVICES (BIO IPS) LLC, 8509 KERNON CT., LORTON, VA, 22079, US

(21) Appl. No.: 11/794,722

(22) PCT Filed: Sep. 5, 2003
(86) PCT No.: PCT/AU2003/001158

§ 371 Date: Aug. 8, 2008

(30) Foreign Application Priority Data
Sep. 5, 2002 (AU) 2002951208

(51) Int. Cl. G03B 21/14

(52) U.S. Cl. 349/7

(57) ABSTRACT

The present invention relates to an image projection device of the type playing images receive via remote means or read from a stored data media. When a mobile phone, the device includes an image projection capability in addition to the standard display. Both the display and the image may be the same or may differ according to the user requirements. The device may also be a smart card or compact disc player that projects an image of the data. The device may further still include a camera to record an image and in the case of a mobile phone transmit it to another receiver. This allows the use of mobile phones for video conferencing.

The present invention relates to a portable image projection device and in particular to one that projects transmitted images or stored images.

### BACKGROUND OF THE INVENTION

In recent years it has become possible to store large quantities of data on data storage media such as compact discs, magnetic cards. Further it has also become technologically possible to transmit large quantities of data using digital signals.

Thus it is now possible to store graphical and video images on small compact discs and magnetic cards. It is also possible to remotely transmit enough information to remote communication units to provide for the display of graphical information with relatively high resolution. This can only improve in the future.

At the same time it has been an object of the designers and manufacturers of various equipment such as portable video players, remote communication or control apparatus, e.g. mobile telephones and cordless phones, to reduce their physical size.

Typically, these devices include various controls, a display screen and a power cell. Whilst it is possible to reduce the size of the controls and power cell without any adverse consequences, reducing the size of the display screen affects the amount of information that can be displayed to the user.

Accordingly, whilst users of such portable video and/or communication or control devices prefer them to be smaller and lighter this forces the display screens to become smaller and smaller reducing the size of the display and thus information content to the user.

Some interim solutions have been proposed such as foldable or sliding panels that may include display screens in the device. Whist this has been moderately successful, the size of the devices is still basically a balance between the overall size and the display screen.

It is therefore an object of the present invention to overcome at least some of the abovementioned problems or provide the public with a useful alternative. This is achieved by providing for a portable video or remote communication device having integral image projection capabilities.

It is a further object of the present invention to provide for a portable video or remote communication device that can project an image from the device to thereby provide for a larger image than would be available on the device display.

### SUMMARY OF THE INVENTION

Therefore in one form of the invention there is proposed an image projection device characterized including;

a display screen for displaying visual information; and

a projecting means for projecting an image from said device.

Advantageously, said device is adapted to remotely receive image data to be displayed by said device. Thus the device may be a mobile or cellular telephone.

Advantageously said projecting means includes a liquid crystal display screen illuminated with light that produces said image to be projected from the device.

Advantageously, said projecting means further includes optical elements selected from but not limited to the group including spectrum filters, polarisers, focussing and magnifications lenses.

Advantageously, said projecting means includes a focussing lens mounted on the front of said device and adjustable for focussing the image.

Advantageously said device further includes a camera adapted to capture an image of a user holding the device.

Advantageously said projecting means and said display show the same image.

In preference the image displayed by the projecting means may be different to that on the display.

In preference said device is a mobile telephone.

Preferably said device is a pager:

Preferably said device is a personal display apparatus.

Advantageously said device is a cordless telephone.

Advantageously said device includes a data media reader.

Advantageously said device is adapted to read smart cards.

Advantageously said device is adapted to read compact discs.

In preference said device further includes a said a television receiver means, said projection means adapted to show broadcast received by said receiver.

In preference said device further includes an internal light source adapted to provide light to illuminate and pass through an LCD so as to construct the image to be projected.

Advantageously said device includes an internal power cell adapted to provide power for the device.

In preference said device further includes an internal memory means to store data.

In preference said device further includes a focussing lens adapted to project said image.

Preferably said device includes at least one mirror foldable between a first and a second position, wherein in said second position the device is adapted to project said image out of said device.

In a further form of the invention there is proposed a mobile or cellular phone including a display means and further including a projecting means adapted to display an addition image to said display means away from said phone.

Advantageously said device is adapted to read and play images from external memory cards through said projecting means.

Of course it is to be understood that other optical components may be necessary to ensure any LCD screen works properly. These have been discussed in the patentees' previous patent applications in relation to LCD projectors whose contents are incorporated herein by reference.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 is a schematic view generally illustrating a remote communication device in accordance with a first embodiment of the present invention;

FIG. 2 is a schematic view illustrating a second embodiment of a remote communication device in accordance with the present invention;

FIG. 3 is a schematic view illustrating a third embodiment of a remote communication device in accordance with the present invention;

FIG. 4 is a cross-sectional view of the device illustrated in FIG. 3;

FIG. 5 is a schematic view illustrating a fourth embodiment of a remote communication device according to the present invention;

FIG. 6 is a simplified schematic view of the device of FIG. 5 when in use;

FIG. 7 is a simplified schematic view of the remote communication device according to the present invention device when in use for video conferencing;

FIG. 8 is a schematic view illustrating the present invention when applied to a compact disc or smart card reader;

FIG. 9 is a schematic representation of a typical smart cart that may be used with the present invention;

FIG. 10 is a schematic representation of a typical compact disc card that may be used with the present invention; and

FIG. 11 is a schematic illustration of the present invention as a combination of a smart card reader and an image projector.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

Shown in FIG. 1 to 7 is the present invention when applied to a remote communication device, such as a mobile phone. In such an embodiment it is assumed that the images to be displayed are ones that have been remotely received by the mobile or cellular phone although it is to be understood that the mobile phone may very well have data or image storage capabilities so that selected images may be stored in the device for subsequent viewing. It is also further envisaged that the remote device may very well be used to transmit any acquired or stored images.

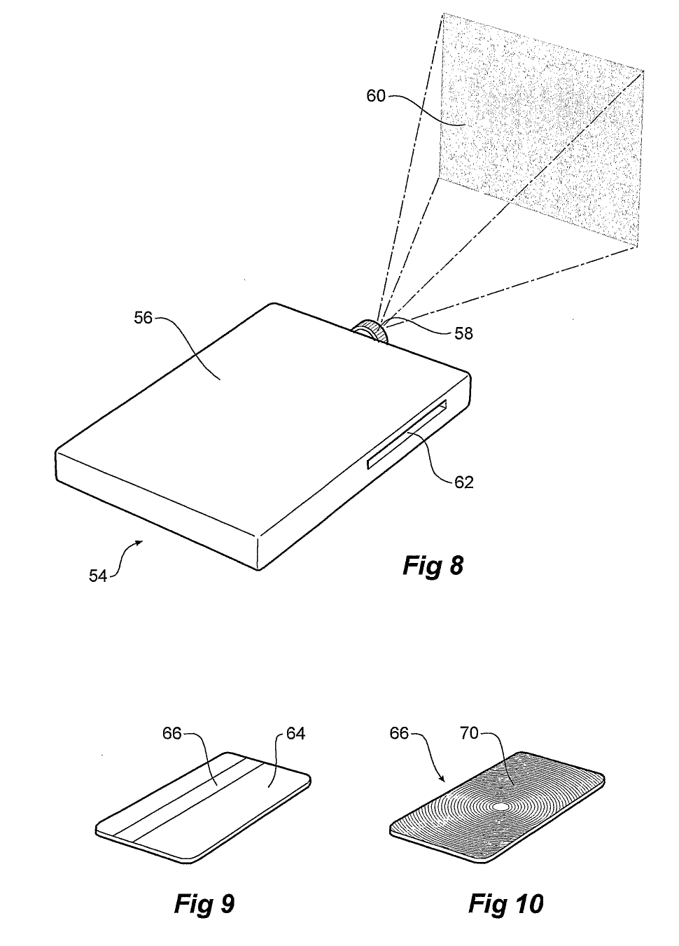

Shown in FIGS. 8 to 11 is the present invention when applied to a data-reading device such as a portable compact disc player, smart card reader or even a magnetic tape such as video tape player (not shown).

We describe the invention as applied to a remote communication device first.

Shown in FIG. 1 is a remote communication device or mobile phone 10 having a body or housing 12. On the front face of the body there are a number of input or control keys 14, a display 16 and a speaker 18 allowing both visual and audio communication. Antenna 20 enables the phone to remotely communicate.

Housed within the body 12 is an optical engine 22 adapted to produce and provide an image that is projected from the front of the body 24 through lens 26. The projected image is then displayed on a suitable surface such as screen 28. However, the image may equally well be projected onto any surface such as a wall.

Although not illustrated in FIG. 1, an optical engine arrangement includes a light source that is first modified by a number of optical filters and/or lenses, and which subsequently passes through a liquid crystal display (LCD) that provides the image that then passes through further optical components and onto screen 28. Thus the image produced by the liquid crystal display is re-created on the screen and by the use of suitable optical components may be enlarged or otherwise manipulated.

The image in the LCD may be the same as that shown in the telephone display 16, but it may also be an alternate image.

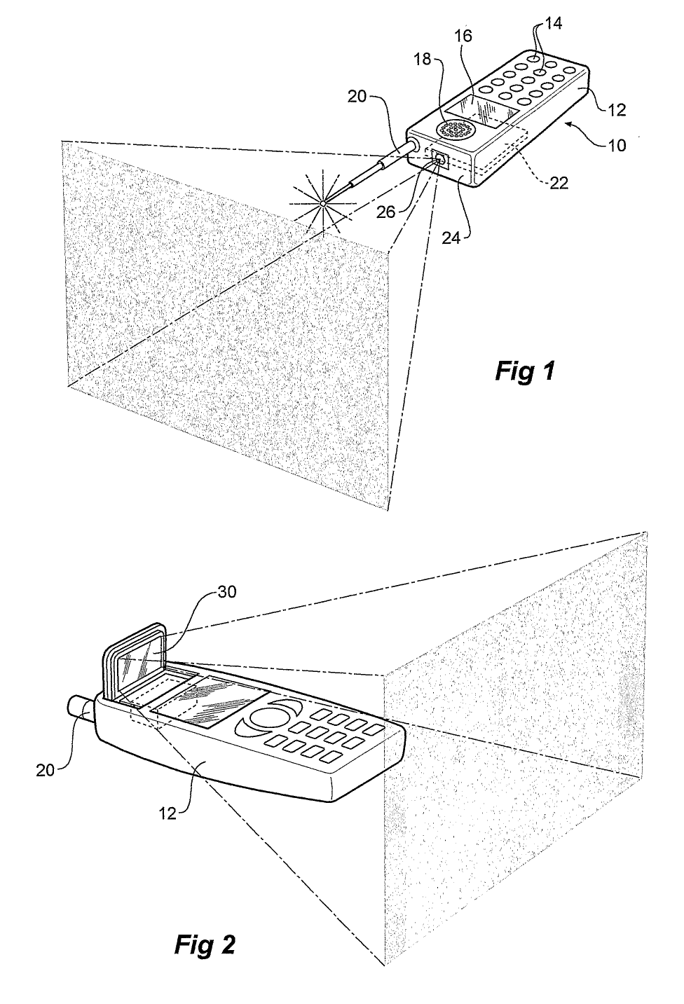

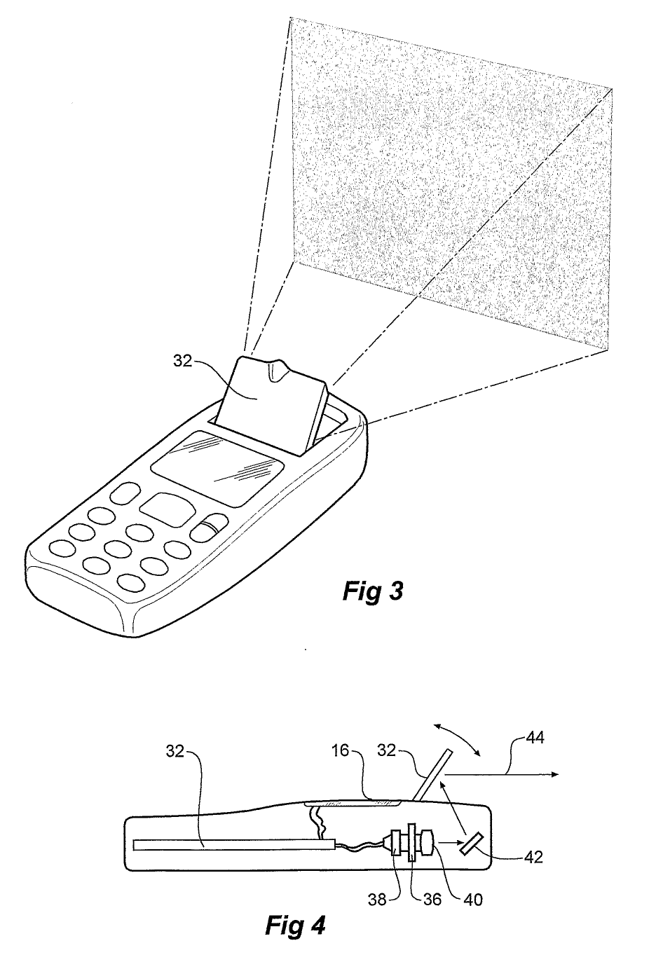

Shown in FIG. 2 is a further arrangement where instead of a lens used to project the image from the remote communication device there is provided a foldable optical mirror 30. This mirror is adapted to fold or flip open between a closed and an open position. IN the open position it re-directs the image of the LCD backwards along the front of the phone. Alternatively, as shown in FIGS. 3 and 4, the mirror 32 may flip open to direct the image forwards from the phone.

Shown in more detail in FIG. 4, but still schematically, are the various components of the device according to the present invention. Thus an electronic control board 34 provides the control signals and the input into both the phone display 16 and LCD 36 by the use of well-known electronic connections and components (not shown). A lamp and optical components 38 provide controlled light that passes through the LCD 36. Further optical components 40, such as lenses and filters, modify the image and re-direct it onto second mirror 42. The second mirror planar surface is at an angle to the direction of the light that has passed through the optical components 36 that results in the image projected out of the axis of the phone and onto mirror 32. The planar surface of the mirror 32 is different to that of the mirror 40 which results in the image being re-directed once again. The angles of the mirrors are chosen so that the image 44 is thus effectively projected out of the phone.

The optical components may include collimating lenses, Fresnel lenses and other focussing and magnification lenses, as well as filters such as infrared, ultra-violet and polarising filters.

The use of the LCD and other appropriate magnification and focussing optical components allows an image to be created that is of a size significantly larger than the common displays found on remote communication equipment. Since the resolution of even small LCD screens may include thousands of individual pixels, the resolution of the projected image is sufficient to be able to create an image of a significant size, such as an A4 size or even larger.

It is to be understood that whilst reference has been made to mobile telephones the present invention may very well be incorporated into other portable electronic devices, such as pagers, personal display apparatus (PDA's), control equipment and the like. In the case of PDA's they may be of a type capable of remote communication, or hard-wired communication as well as stand-alone devices having data media readers.

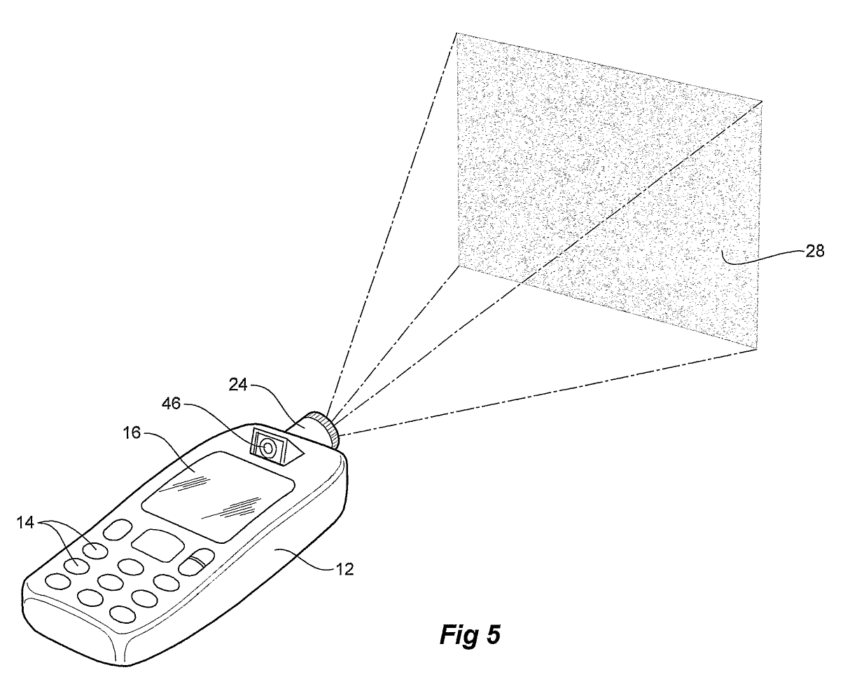

Shown in FIG. 5 is further embodiment of the present invention. A phone 10 may further include a camera, typically a CCD (charge coupled device) 46 that records the image of the person 48 in view of the camera. The camera may be adapted to be retractable within the body 12 of the phone, so as to prevent it from being damaged when not in use.

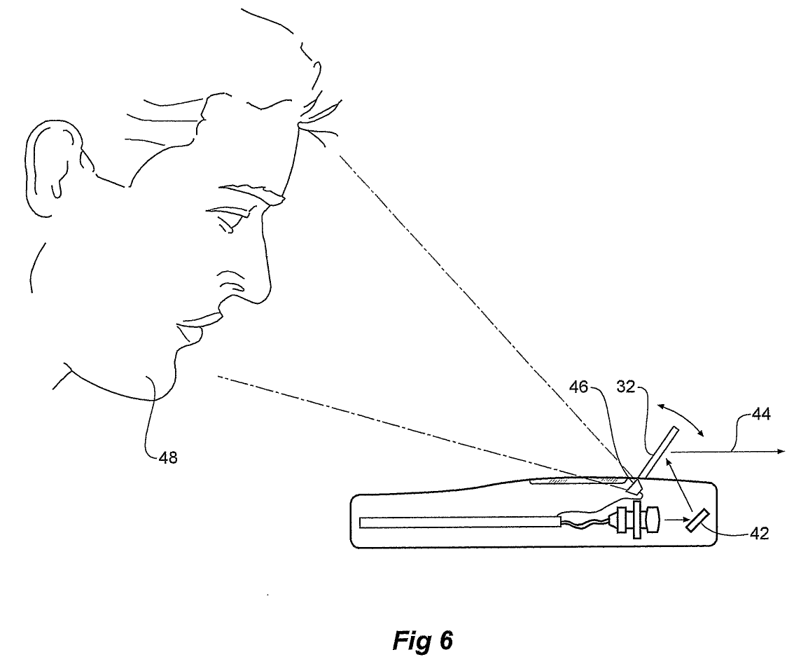

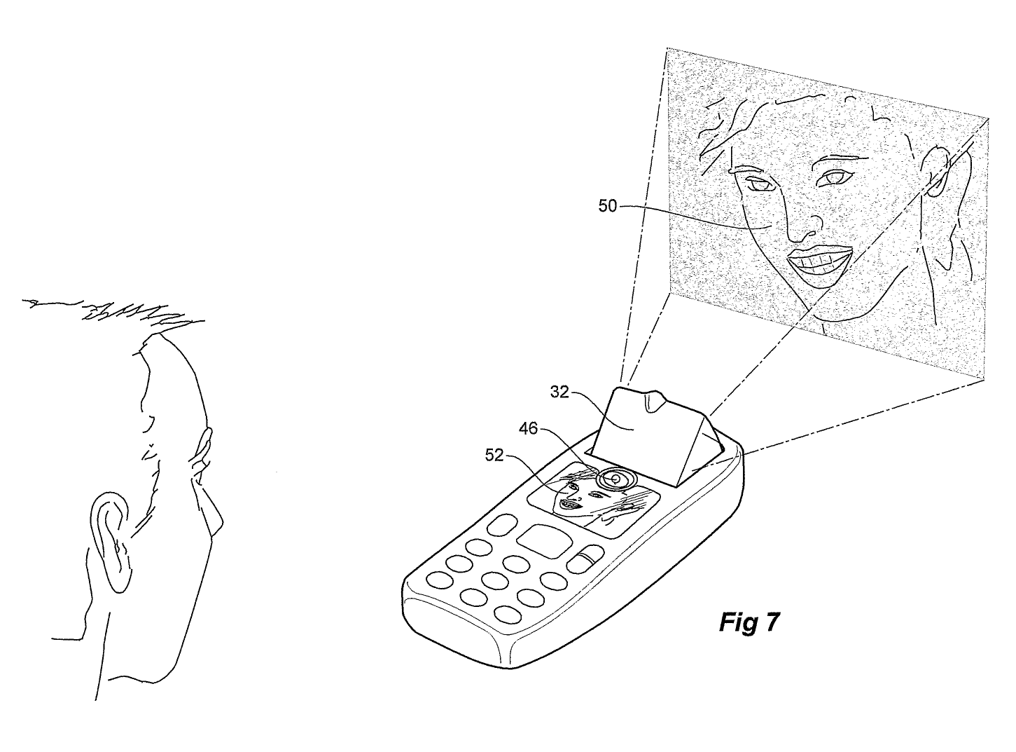

A camera 46 may also be used in a phone having the foldable projecting mirror, this embodiment illustrated in FIGS. 6 and 7.

Thus a mobile telephone incorporating an image projecting device may be successfully used for video conferencing because the image projection allows a larger image 50 to be provided than image 52 provided by a conventional display. Of course, there is no suggestion that the image in the display and that projected may be the same. In fact, at times it may be desirable for the image shown in the display to be different to that projected. It even may be that a person could very well project his or her own image that has been taken by the camera within the phone.

The device may also be used to project normal television pictures. Thus, in some areas, the device may include a television tuner that receives a television broadcast and projects that image onto a surface, at the same time being able to be used as a conventional communication device. It is therefore to be understood that the projected image need not be the same as that displayed on the normal display.

It can therefore be seen that the device according to the present invention allows one to provide both visual and audio communication including a larger image by projecting the image out of the device. This ensures that the device itself is still very portable.

Suitable power cells will be necessary to provide sufficient light to project the image. There may also be an electrical input into the device, so that it may be run directly from mains power when it is being used, for example, in a hotel room as a television receiver.

The apparatus may further include an input port for reading memory cards or other data storage media. Thus a memory card may include a video or Mpeg file that may be displayed directly by the projection LCD. In addition, the communication device could also transmit that image to a receiver.

Alternatively the device itself may also include a memory card so that images that are received by the phone may be stored within the phone and played later either on the display screen or through the projection device.

Further, the ability to provide and additional display by virtue of the projection LCD means that the normal display of the device may still be used for displaying general status of the device. The LCD may also be used so that a portion of the projected image includes that seen on the display.

Referring now to FIGS. 8 to 11, the present invention also provides for a device that does not include any remote communication capabilities but is used to display information that is read by the device from compact discs or smart cards. Such as device 54 illustrated in FIG. 8 may simply include a housing 56 having internal optical components (not shown) that include a LCD used to construct an image. A light source then provide the light that passes through the LCD, various optical components and finally through lens 58 to display image 60. The device includes an internal card reader. These cards are inserted into the device through slot 62. The device would also include various control mechanisms, though these are not shown the drawings being for illustrative purposes only.

The cards may be magnetic type cards as illustrated in FIG. 9 where the card 64 includes a magnetic strip 66. Alternatively the cards may be a compact disc or CD card 68 where the information is found on the back of the card in the form of CD tracks 70 as illustrated in FIG. 10.

Such magnetic or compact disc cards are becoming well known and may contain significant amounts of information besides images. In fact these cards may typically be collectable cards that may be purchased or swapped by people. The device 54 may therefore be used to not only play the cards as may be done by teenagers collecting cards about sporting heroes and then playing them for their leisure, but may also be used by people to test the quality and authenticity of any cards they are about to purchase or swap. Although the units may be small, the image projection capabilities allow adequately large images to be displayed for viewing by multiple parties.

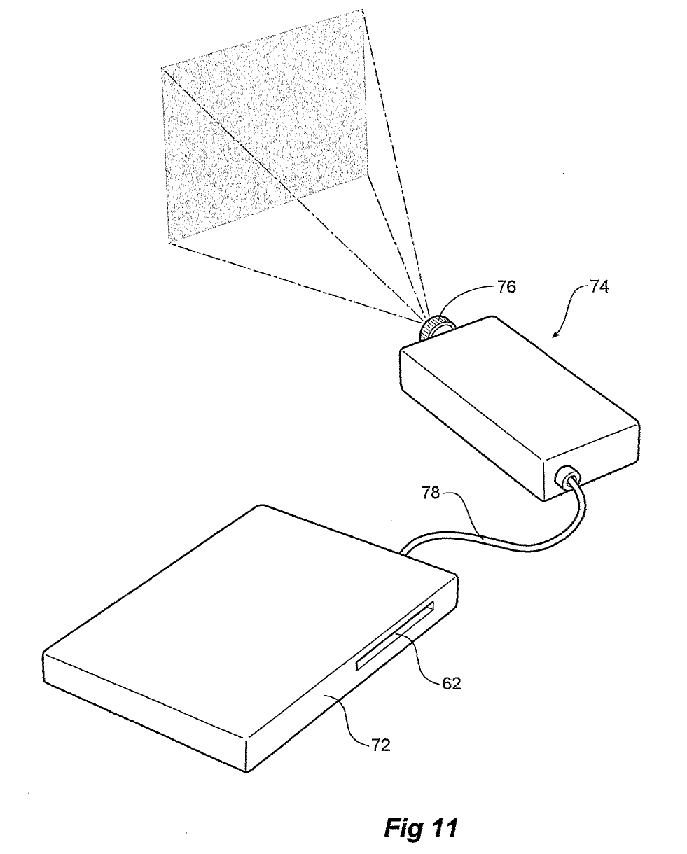

Shown in FIG. 11 is a further embodiment of such a smart card reader, wherein the reading and image capabilities are provided in separate but integrally connected devices. Thus a smart card or CD reader 72 provides the information to a separate projector 74 through data communication cable 76. The projector 74 includes the internal LCD panel producing an image that ultimately is projected through lens 76.

It is not intended to limit such a device to a lens used to project an image. Thus the device, as with the remote communication device described above, may equally well use foldable mirrors that re-direct the image to a suitable surface for viewing.

Further, the smart reader type device may also include an integral display. This would enable one to both view images read from a smart card on the device as well as project it from the device for viewing by other parties or to simply provide a larger image. It is also not intended to limit the preset device to only one type of data reader. Thus the device could very well be used to read smart cards as well as compact discs and magnetic strips.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

1. An image projection device including;
a display screen for displaying visual information; and
a projecting means for projecting an image from said device.

2. An image projection device as in claim 1 wherein said device is adapted to remotely receive image data to be displayed by said device.

3. An image projection device according to any one of the preceding claims, wherein said projecting means includes a liquid crystal display screen illuminated with light that produces said image to be projected from the device.

4. An image projection device according to any one of the preceding claims, wherein said projecting means further includes optical elements selected from but not limited to the group including spectrum filters, polarisers, focussing and magnifications lenses.

5. An image projection device according to any one of the preceding claims, wherein said projecting means includes a focussing lens mounted on the front of said device and adjustable for focussing the image.

6. An image projection device according to any one of the preceding claims, wherein said device further includes a camera adapted to capture an image of a user holding the device.

7. An image projection device according to any one of the preceding claims, wherein said projecting means and said display show the same image.

8. An image projection device as in any one of claims 1 to 6 wherein the image displayed by the projecting means may be different to that on the display.

9. An image projection device according to any one of the preceding claims, wherein said device is a mobile telephone.

10. An image projection device as in any one of claims 1 to 8 wherein said device is a pager.

11. An image projection device as in any one of claims 1 to 8 wherein said device is a personal display apparatus.

12. An image projection device as in any one of claims 1 to 8 wherein said device is a cordless telephone.

13. An image projection device as in any one the above claims wherein said device includes a data media reader.

14. An image projection device as in claim 13 wherein said device is adapted to read smart cards.

15. An image projection device as in claim 13 wherein said device is adapted to read compact discs.

16. An image projection device according to any one of the preceding claims, further including a said a television receiver means, said projection means adapted to show broadcast received by said receiver.

17. An image projection device according to any one of the preceding claims, including an internal light source adapted to provide light to illuminate and pass through said LCD so as to construct the image to be projected.

18. An image projection device according to any one of the preceding claims, including an internal power cell adapted to provide power for the device.

19. An image projection device as in anyone of the above claims further including an internal memory means to store data.

20. An image projection device according to any one of the preceding claims, including a focussing lens adapted to project said image.

21. An image projection device as in any one of claims 1 to 20 further including at least one mirror foldable between a first and a second position, wherein in said second position the device is adapted to project said image out of said device.
